(19) United States
(12) Patent Application Publication
(10) Pub. No.: US 2004/0160402 A1
(43) Pub. Date: Aug. 19, 2004

(54) Method and apparatus for driving a liquid crystal display by generating color-specific gray voltages

(76) Inventors: Sang-Soo Kim, Seoul (KR); Jheen-Hyeok Park, Seongnam-city (KR); Seung-Hwan Moon, Yongin-city (KR); Gyu-Su Lee, Suwon-city (KR)

Correspondence Address: GRAY CARY WARE & FREIDENRICH LLP, 2000 UNIVERSITY AVENUE, E. PALO ALTO, CA, 94303-2248, US

(21) Appl. No.: 10/773,776

(22) Filed: Feb. 6, 2004

(30) Foreign Application Priority Data
Feb. 6, 2003 (KR) 2003-0007521

(51) Int. Cl. G09G 3/36

(52) U.S. Cl. 345/89

(57) ABSTRACT

The invention is an apparatus for driving a liquid crystal display. In the invention, the digital data signals for different pixels are converted to analog signals based on color-specific gray voltages. By providing color-specific gray voltages, the invention corrects any bias stemming from different electro-optical characteristics of different-colored pixels. In one embodiment, the invention includes a signal controller for generating digital data signals for different pixel colors and a gray voltage generator for generating gray voltage signals that are specific to the different pixel colors. A data driver, which is coupled to the gray voltage generator and the signal controller, converts each one of the digital signals to a corresponding analog signal by using one of the gray voltage signals that is associated with the same pixel color as the digital signal that is being converted.

### RELATED APPLICATION

This application claims priority, under 35 USC § 119, from Korean Patent Aplication No. 2003-0007521 filed on Feb. 6, 2003, the content of which is incorporated herein by reference in its entirety.

### BACKGROUND OF THE INVENTION

1. Field of the Invention

The present invention relates to liquid crystal display and an apparatus and method of driving a liquid crystal display.

2. Description of the Related Art

A liquid crystal display (LCD) includes a panel with pixel electrodes, a panel with a common electrode, and a liquid crystal (LC) layer interposed between the two panels. The LC layer contains liquid crystals with dielectric anisotropy. The pixel electrodes are arranged in a matrix of rows and columns and connected to switching elements, such as thin film transistors (TFTs), which supply the pixel electrodes with data voltages. Typically, the data voltages are supplied row by row. The common electrode covers the entire surface of one of the two panels and is supplied with a common voltage. The pixel electrode, the common electrode, and the LC layer form an LC capacitor, which is a basic element of a pixel along with the switching element connected thereto.

Voltages are applied to the two electrodes to generate an electric field in the LC layer, and the transmittance of light passing through the LC layer is adjusted by controlling the strength of the electric field. Thus, desired images can be displayed by controlling the electric field. In order to prevent image deterioration due to long-time application of the unidirectional electric field, etc., polarity of data voltages with respect to the common voltage is reversed every frame, every row, or every dot.

The LCD includes a data driver for supplying data voltages to the pixel electrodes, which includes a shift register, a data register, a data latch, a digital-to-analog (D/A) converter, and an output buffer. The data driver latches digital image data for red (R), green (G), and blue (B) colors that are sequentially received from a timing controller in synchronization with a dot clock, converts the digital data into analog voltages, and outputs the analog voltages to the pixels. The D/A conversion of the image data into the analog voltages is performed by a D/A converter in reference to gamma reference voltages received from an external device.

A conventional LCD utilizes the same gamma reference voltage for the different colors under the assumption that the different-colored pixels have the same electro-optical characteristics. However, the red, green and blue pixels actually have different electro-optical characteristics. Thus, the color conception is non-uniform or biased.

In an attempt to improve color conception, LCDs that use separate gamma reference voltages for the respective colors have been made. However, this use of separate gamma reference voltages usually increases the number of pins of the data driver, thereby increasing the size of the data driver. Also, additional blocks for generating gamma reference voltages for individual colors are required. The increased number of voltage generating circuits and the larger data driver size undesirably increases the manufacturing cost of the LCD.

LCDs would benefit from a method of correcting the bias in the color conception without increasing the number of pins or components.

### SUMMARY OF THE INVENTION

In one aspect, the invention is an apparatus for driving a liquid crystal display. The apparatus includes a signal controller for generating digital signals for different pixel colors, and a gray voltage generator coupled to the signal controller, wherein the gray voltage generator generates gray voltage signals for each of the different pixel colors. A data driver that is coupled to the gray voltage generator and the signal controller converts each of the digital signals to a corresponding analog signal by identifying one of the gray voltage signals that is associated with the same pixel color as a digital signal that is being converted.

In another aspect, the invention is a liquid crystal panel assembly. The liquid crystal panel assembly includes a plurality of pixel electrodes, wherein each of the pixel electrodes is associated with a pixel color, a common electrode positioned substantially parallel to the pixel electrodes, and a liquid crystal layer positioned between the pixel electrodes and the common electrode. The panel assembly further includes a data driver for supplying data signals to the pixel electrodes and a gray voltage generator that is coupled to the pixel electrodes. The gray voltage generator generates gray voltages that are each associated with a pixel color, so that the data driver determines a particular data signal for a particular pixel electrode by using one of the gray voltages that is associated with the pixel color of the particular pixel electrode.

The invention also includes a method of driving a liquid crystal display. The method entails generating gray voltages for different pixel colors, receiving digital data for pixels having different pixel colors, and converting the digital data to a corresponding analog data by using one of the gray voltages that is associated with a same pixel color as the digital data being converted.

### BRIEF DESCRIPTION OF THE DRAWINGS

The present invention will become more apparent by describing embodiments thereof in detail with reference to the accompanying drawing in which:

FIG. 1 is a block diagram of electronic components of an LCD according to an embodiment of the present invention;

FIG. 2 is a schematic diagram of a pixel of an LCD according to an embodiment of the present invention;

FIG. 3 is another block diagram of electronic components of an LCD according to an embodiment of the present invention; and

FIG. 4 is yet another block diagram of electronic components of an LCD according to an embodiment of the present invention.

### DETAILED DESCRIPTION OF EMBODIMENTS

The present invention now will be described more fully hereinafter with reference to the accompanying drawings, in which embodiments of the invention are shown. In the drawings, the thickness of layers and regions are exaggerated for clarity. Like numerals refer to like elements throughout.

Embodiments of the invention are described herein in the context of color pixels and more specifically in the context of red, green, and blue pixels. However, it is to be understood that the embodiments provided herein are exemplary embodiments, and the scope of the invention is not limited to the applications or the embodiments disclosed herein. For example, the invention may be used for any pixels that have different electro-optical characteristics, regardless of whether this difference stems from a difference in color.

It will be understood that when an element, such as a layer, a region or a substrate, is referred to as being “on” (e.g., positioned on, provided on, located on) another element, it can be directly on the other element or intervening elements may also be present. In contrast, when an element is referred to as being “directly on” another element, there are no intervening elements present.

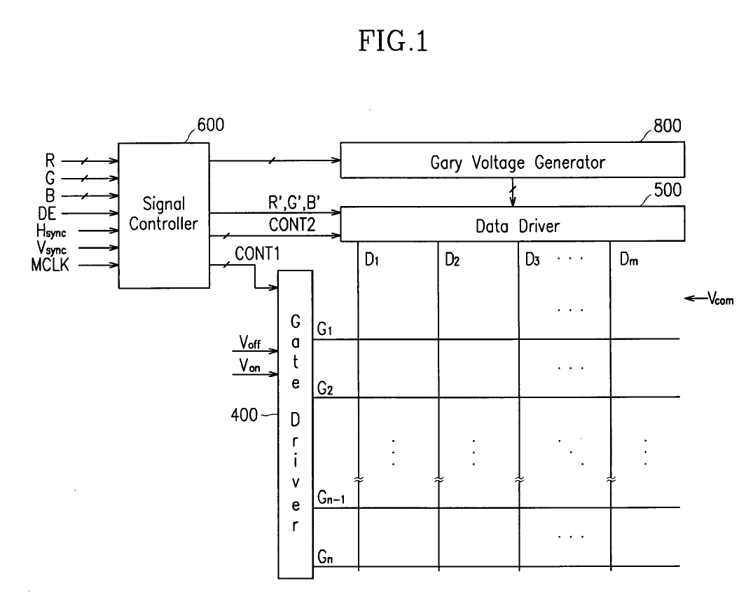

Referring to FIG. 1, an LCD according to an embodiment of the present invention includes a liquid crystal panel assembly (not shown), a gate driver 400 and the data driver 500 connected to the panel assembly, a digital gray voltage generator 800 connected to the data driver 500, and a signal controller 600 controlling the above-described elements.

The display signal lines include a plurality of gate lines G₁-Gₙ for transmitting gate signals (also referred to as “scanning signals”) and a plurality of data lines D₁-Dₘ for transmitting data signals. The gate lines G₁-Gₙ are arranged in rows and extend substantially parallel to each other. The data lines D₁-Dₘ are arranged substantially perpendicularly to the rows (i.e., in columns) and extend substantially parallel to each other.

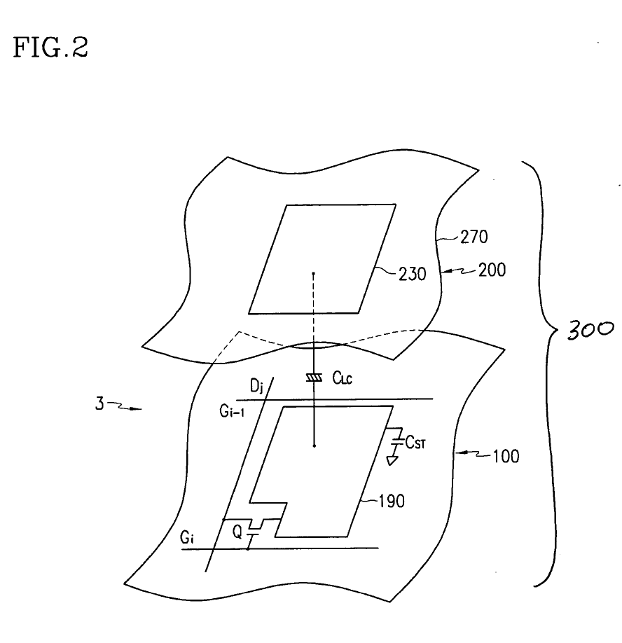

Referring to FIG. 2, a liquid crystal panel assembly 300 includes a first panel 100, a second panel 200, and a liquid crystal layer 3 between the two panels 100, 200. The liquid crystal panel assembly 300 also includes a plurality of display signal lines G₁-Gₙ and D₁-Dₘ connected to a plurality of pixels that are arranged approximately in a matrix, as shown in FIG. 1.

Each pixel includes a switching element Q connected to the signal lines G₁-Gₙ and D₁-Dₘ, and an LC capacitor C_{LC} and a storage capacitor C_{ST} that are connected to the switching element Q. Depending on the embodiment, the storage capacitor C_{ST} may be omitted.

The switching element Q is provided on the first panel 100 and has three terminals: a control terminal connected to one of the gate lines G₁-Gₙ; an input terminal connected to one of the data lines D₁-Dₘ; and an output terminal connected to both the LC capacitor C_{LC} and the storage capacitor C_{ST}.

The LC capacitor C_{LC} includes a pixel electrode 190 provided on the first panel 100 and a common electrode 270 provided on the second panel 200 as two terminals. The LC layer 3 disposed between the two electrodes 190 and 270 functions as the dielectric material of the LC capacitor C_{LC}. The pixel electrode 190 is connected to the switching element Q. The common electrode 270 is connected to the common voltage V_{com} and covers the entire surface of the second panel 200. In some embodiments, the common electrode 270 may be provided on the first panel 100 and the electrodes 190 and 270 may have shapes that are different from what is depicted in FIG. 2.

The storage capacitor C_{ST} is formed by the pixel electrode 190 and a separate wire (not shown) located on the first panel 100. The wire is supplied with a predetermined voltage such as the common voltage V_{com.}Alternatively, the storage capacitor C_{ST} may be formed by the pixel electrode 190 and its previous gate line Gᵢ₋₁ sandwiching an insulating material.

In a color display, each pixel is a color pixel for passing light through a color filter 230 (e.g., a red, green, or blue color filter). The color filter 230 is located over an area of the LC layer that is controlled by the pixel electrode 190. Although the color filter 230 is shown to be located in the second panel 200 in FIG. 2, the invention is not so limited. In some embodiments, the color filter 230 is positioned on or under the pixel electrode 190 on the first panel 100.

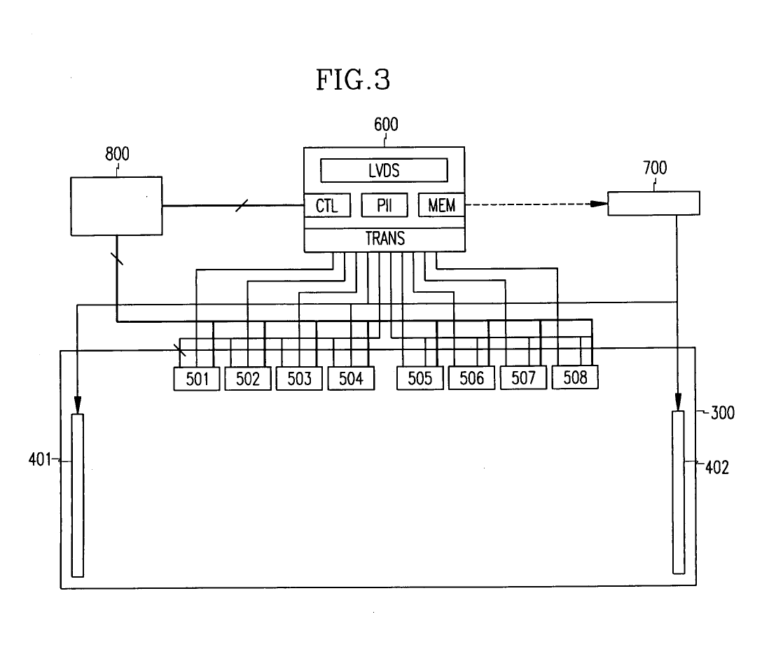

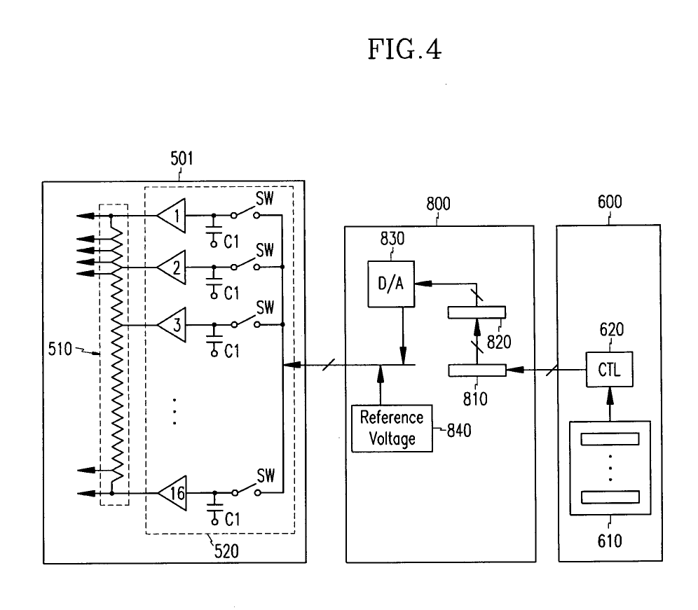

Referring to FIGS. 3 and 4, the digital gray voltage generator 800 generates gray voltages. The gray voltage generator 800 includes a pair of gamma registers 810 and 820 sequentially connected by ten buses and a 10-bit D/A converter 830 connected to one of the gamma registers 810, 820 through 10-bit buses. As shown in FIG. 3, the gamma-registers 810 and 820 are connected to the signal controller 600 through multiple (e.g., two) buses and receive and store R, G, and B gamma voltage data separately. The signal controller 600 separately transmits the R, G and B gamma voltages through different buses and the registers 810 and 820 store the gamma voltage data for one of the colors. Although there may be other registers for other colors, registers for only one color is shown for clarity of illustration. The internal structures of reference numerals 800 and 501 shown in FIG. 4 concern only one color. The D/A converter 830 converts the digital data stored in the gamma registers 810, 820 to analog signals for every color and every polarity based on reference voltages 840, and outputs the analog data to the data driver 500 through two bus lines. The signal controller 600 includes a 10-bit register 610 storing a predetermined number of (e.g., 16 for a total of 256 grays) digital gamma data, which will be supplied for the gray voltage generator 800 through the controller 620. The above-described configuration generates independent RGB gamma curves.

The gate driver 400 is connected to the gate lines G₁-Gₙ on the liquid crystal panel assembly 300. The gate driver 400 receives gate signals having a gate-on voltage Vₒₙ and a gate-off voltage V_{off} from an external device and applies them to the gate lines G₁-Gₙ. As shown in FIG. 3, the gate driver 400 may be divided into two gate sub-drivers 401 and 402 mounted on different portions of the liquid crystal panel assembly 300. The gate sub-drivers 401 and 402 receive voltages from the signal controller 600 through the level shifter 700.

The data driver 500 includes a plurality of data driving ICs 501-508 mounted on the liquid crystal panel assembly 300 and is connected to the data lines D₁-Dₘ on the liquid crystal panel assembly 300. The data driver 500 receives gray voltages from the gray voltage generator 800, selects data voltages among the gray voltages, and applies the data voltages to the data lines D₁-Dₘ.

The driving ICs 501-508 are connected to the D/A converter 830 of the gray voltage generator 800, and two buses from the gray voltage generator 800 are divided to be connected to the driving ICs 501-508.

The driving ICs 501-508 are also connected to the signal controller 600 and receive image data and data control signal therefrom. An exemplary data control signal is a 2-bit clock signal. A bus from the signal controller 600 is divided to be connected to the data driving ICs 501-508. The image data are supplied from the signal controller 600 to the data driving ICs 501-508 by two signal lines separately connecting the data driving ICs 501-508 to the signal controller 600. These connections and configurations are disclosed in detail in SID 01 DIGEST pp. 106-109 (“An Advanced Interconnect Link For TFT Column Driver Data”), which is incorporated herein by reference. This connection configuration significantly reduces electromagnetic interference (EMI).

The data driver 500 includes a shift register (not shown), a data register (not shown), a data latch (not shown), a D/A converter (not shown), and an output buffer (not shown). The shift register stores R, G, and B data transmitted from the signal controller 600 into the data register. The D/A converter receives the data stored in the data register through the data latch and converts the data into analog data voltages. The output buffer stores the analog data voltages supplied from the D/A converter and applies the data voltages to the data lines in response to a load signal.

FIG. 4 shows the driving IC 501 in greater detail. Although driving ICs 502-508 are not shown in the figure, they are substantially similar to the driving IC 501. The D/A converter of the data driving IC 501-508 includes a sampling/holding unit 520 and a series of resistors. As shown, resistors 510 in the driving IC 501 connect the 16 sampling circuits.

The sampling/holding unit 520 includes sixteen sampling/holding circuits for sampling the data from the D/A converter 830 of the gray voltage generator 800, which includes eight circuits for positive voltages and eight circuits for negative voltages. The sampled voltages are applied to nodes between the resistors 510 as shown in FIG. 4 such that they determine the finalized values of the gray voltages output from the nodes as indicated by the arrows. Each sampling/holding circuit includes a switch SW, a capacitor C1, and a buffer B₁-B₁₆. When a switch SW turns on in response to a sampling start signal, reference gamma voltages from the D/A converter are sampled and stored in the capacitors C1, and the sampled gamma reference voltages are output from the analog buffers B₁-B₁₆. The output voltages are divided into a plurality of gray voltages, for example, 256 positive analog gray voltages and 256 negative analog gray voltages (2⁸=256).

Now, the operations of the LCD will be described in detail.

The signal controller 600 is supplied with RGB image signals R, G and B and input control signals controlling the display thereof from an external graphic controller (not shown). The input control signals include a vertical synchronization signal V_{sync}, a horizontal synchronization signal H_{sync}, a main clock MCLK, a data enable signal DE, etc. On the basis of the image data and the input control signals, the signals controller 600 processes the image data to be suitable for the gate and data drivers 400 and 500 and the liquid crystal panel assembly 300, generates a plurality of gate control signals CONT1 for the gate driver 400 and the processed image data R′, G′ and B′, and the data control signals CONT2 for the data driver 500.

The gate control signals CONT1 include a vertical synchronization start signal STV for instructing to start outputting a gate-on voltage Vₒₙ, a gate clock signal CPV for controlling the output time of the gate-on voltage Vₒₙ, and an output enable signal OE for defining the duration of the gate-on voltage Vₒₙ.

The data control signals CONT2 include a horizontal synchronization start signal STH for instructing to start inputting the processed image data R′, G′ and B′, a load signal LOAD for instructing to apply data voltages to the data lines D₁-Dₘ, an inversion signal RVS for reversing the polarity of the data voltages (with respect to the common voltage V_{com}), and a data clock signal HCLK.

The control signals CONT1 and CONT2 may be transmitted through buses for the transmission of the image data.

The data driver 500 receives a packet of the image data R′, G′, and B′ for a pixel row from the signal controller 600 and converts the image data R′, G′, and B′ into data voltages selected from the analog gray voltages in response to the data control signals CONT2 from the signal controller 600. The data driver 500 then outputs the data voltages to the data lines D₁-Dₘ.

Responsive to the gate control signals CONT1 supplied from the signal controller 600, the gate driver 400 applies the gate-on voltage Vₒₙ to the selected gate line G₁-Gₙ, thereby turning on the switching elements Q connected thereto. The data voltages applied to the data lines D₁-Dₘ are supplied to the pixels through the activated switching elements Q.

The difference between the data voltage and the common voltage V_{com} is represented as a voltage across the LC capacitor C_{LC}, i.e., the pixel voltage. The LC molecules in the LC capacitor C_{LC} have orientations depending on the magnitude of the pixel voltage, and the molecular orientations determine the polarization of light passing through the LC layer 3. A polarizer or polarizers (not shown) attached to at least one of the panels 100 and 200 convert the light polarization into the light transmittance.

By repeating this procedure by a unit of a horizontal period (which is indicated by 1H and equal to one period of the horizontal synchronization signal Hsync, the data enable signal DE, and a gate clock signal), all gate lines G₁-Gₙ are sequentially supplied with the gate-on voltage Vₒₙ during a frame, thereby applying the data voltages to all pixels. When the next frame starts after finishing one frame, the inversion control signal RVS applied to the data driver 500 is controlled such that the polarity of the data voltages is reversed (which is called “frame inversion”). The inversion control signal RVS may be also controlled such that the polarity of the data voltages flowing in a data line in one frame are reversed (which is called “line inversion”), or the polarity of the data voltages in one packet are reversed (which is called “dot inversion”).

The numbers described in the embodiments herein are based on the assumption that the number of the total gray voltages is 256. A person of ordinary skill in the art will understand that these numbers may vary depending on the number of gray voltages.

The gate driver and the data driver, instead of having chip types, may be incorporated into the liquid crystal panel assembly by forming the elements of the drivers using the processes for forming the switching elements of the pixels and the display signal lines.

The provision of separate signal lines between the signal controller and the respective data driving ICs reduces EMI. Furthermore, the individual gamma reference voltages for the red, green and blue colors facilitate to adjust color temperature and color coordinates. The adjustment of the color temperature and the color coordinates enlarges the color representation, which may be limited by the liquid crystal characteristics and color filters, to realize the various color representation.

Furthermore, the signal controller supplies digital gamma values such that the gamma can be varied depending on the frames, and thus the dynamic luminance ratio for motion picture can be increased to realize dynamic images. It is preferable that the configuration of the signal controller is changed to be suitable for the driving ICs. That is, it is preferable that the signal controller transmits R, G and B gamma values in digital format when it is powered, and it analyzes the input image data and adjusts the gamma values when the dynamic images are required.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. An apparatus for driving a liquid crystal display, the apparatus comprising:
a signal controller for generating digital signals for different pixel colors;
a gray voltage generator coupled to the signal controller, wherein the gray voltage generator generates gray voltage signals that are specific to the different pixel colors; and
a data driver coupled to the gray voltage generator and the signal controller, wherein the data driver converts each one of the digital signals to a corresponding analog signal by selecting one of the gray voltage signals that is associated with the same pixel color as the digital signal that is being converted.

2. The apparatus of claim 1, wherein the gray voltage generator separately stores gray voltages for each of the pixel colors and for each voltage polarity.

3. The apparatus of claim 1, wherein the gray voltage generator comprises:
a first color-specific gamma voltage register; and
a second color-specific gamma voltage register coupled to the first gamma voltage register wherein the first and second color-specific gamma voltage registers store digital gamma voltages received from the signal controller, for a specific pixel color.

4. The apparatus of claim 3, wherein the gray voltage generator further comprises a digital-to-analog converter for converting the digital gamma voltages that are stored in the first and the color-specific second gamma voltage registers into analog gray voltages.

5. The apparatus of claim 4, wherein the first color-specific gamma voltage register and the second color-specific gamma voltage register are connected by a first set of ten-bit buses, and at least one of the first and second color-specific gamma voltage registers is connected to the digital-to-analog converter by a second set of ten-bit buses.

6. The apparatus of claim 4, wherein the data driver comprises a plurality of data driving circuits for receiving image data and data control signals from the signal controller, wherein each of the data driving circuits includes a sampling unit for sampling gamma voltage data from the digital-to-analog converter.

7. The apparatus of claim 6, wherein the sampling unit comprises a plurality of sampling circuits, each of which includes:
a switch that turns on in response to a sampling signal from the signal controller;
a capacitor coupled to the switch for storing the sampled gamma voltage data; and
an analog buffer coupled to the capacitor for outputting the stored gamma voltage data.

8. The apparatus of claim 6, wherein the image data are transmitted from the signal controller to the data driving circuits by two signal lines that are separately connected between the data driving circuits and the signal controller.

9. The apparatus of claim 1, wherein the gray voltage generator is coupled to the data driver by a plurality of buses.

10. The apparatus of claim 1, wherein the signal controller comprises a register for storing a predetermined number of digital gamma data, wherein the digital gamma data are supplied to the gray voltage generator for generating independent gamma curves for the different pixel colors.

11. The apparatus of claim 1 further comprising a gate driver coupled to the signal controller, wherein the gate driver generates gate control signals in response to signals from the signal controller.

12. A liquid crystal panel assembly comprising:
a plurality of pixel electrodes, wherein each of the pixel electrodes is associated with a pixel color;
a common electrode positioned substantially parallel to the pixel electrodes;
a liquid crystal layer positioned between the pixel electrodes and the common electrode;
a data driver for supplying data signals to the pixel electrodes; and
a gray voltage generator coupled to the pixel electrodes, wherein the gray voltage generator generates gray voltages that are each associated with a pixel color, so that the data driver determines a particular data signal for a particular pixel electrode by using one of the gray voltages that is associated with the pixel color of the particular pixel electrode.

13. The panel assembly of claim 12, wherein the gray voltage generator separately stores gray voltages for each pixel color and voltage polarity.

14. The panel assembly of claim 12, wherein the gray voltage generator comprises:
a first gamma voltage register; and
a second gamma voltage register coupled to the first gamma voltage register, wherein the first and second gamma voltage registers store gray voltages for each pixel color separately.

15. The panel assembly of claim 14, wherein the gray voltage generator further comprises a digital-to-analog converter for converting the digital data stored in the first and the second gamma voltage registers into analog gray voltages.

16. The panel assembly of claim 15, wherein the first gamma voltage register and the second gamma voltage register are connected by a first set of ten-bit buses, and at least one of the first and second gamma voltage registers is connected to the digital-to-analog converter by a second set of ten-bit buses.

17. The panel assembly of claim 15 further comprising a signal controller coupled to the data driver, wherein the data driver comprises a plurality of data driving circuits for receiving image data and data control signals from the signal controller, wherein each of the data driving circuits includes a sampling unit for sampling gamma voltage data from the digital-to-analog converter.

18. The panel assembly of claim 17, wherein the sampling unit comprises a plurality of sampling circuits, each of the sampling circuits including:
a switch for controlling the sampling of the gamma voltage data;
a capacitor coupled to the switch for storing the sampled gamma voltage data; and
an analog buffer coupled to the capacitor for outputting the stored gamma voltage data.

19. The panel assembly of claim 17, wherein the image data are transmitted from the signal controller to the data driving circuits by two signal lines that are separately connected between the data driving circuits and the signal controller.

20. The panel assembly of claim 17, wherein the signal controller comprises a register for storing a predetermined number of digital gamma data, wherein the digital gamma data are supplied to the gray voltage generator for generating independent gamma curves for different pixel colors.

21. The panel assembly of claim 12, wherein the gray voltage generator is coupled to the data driver by a plurality of buses.

22. A method of driving a liquid crystal display, the method comprising:
generating gray voltages for different pixel colors;
receiving digital data for pixels having different pixel colors;
converting the digital data to a corresponding analog data by using one of the gray voltages that is associated with a same pixel color as the digital data being converted.

23. The method of claim 22 further comprising storing the gray voltages separately according to pixel colors.

24. The method of claim 22 further comprising generating independent gamma curves for different pixel colors, wherein gamma curves are used for converting the digital data to the corresponding analog data.
